(19) United States
(12) Patent Application Publication
(10) Pub. No.: US 2016/0274379 A1
(43) Pub. Date: Sep. 22, 2016

(54) FLUID LENS ASSEMBLY INCLUDING FLUID ADJUSTING UNIT

(71) Applicant: Oceanus Investment Inc., Mahe Republic of Seychelles (SC)

(72) Inventors: David CHAO, Saratoga, CA (US); Chien-Ho LIN, Chiayi (TW)

(21) Appl. No.: 14/662,952

(22) Filed: Mar. 19, 2015

(51) Int. Cl. G02C 7/08; G02C 1/08; G02C 5/02; G02C 5/14

(52) U.S. Cl. CPC G02C 7/085; G02C 5/14; G02C 1/08; G02C 5/02; G02C 2200/18

(57) ABSTRACT

A fluid lens assembly includes: a fluid lens unit including at least one fluid lens; a temple unit connected to the fluid lens unit and having a reservoir; at least one fluid adjusting unit counted to the temple unit and including a piston head that is mounted in the reservoir, a plunger that is connected to the piston head, and a driving member that is mounted movably to the temple unit and that is coupled to the plunger for driving sliding movement of the plunger and the piston head relative to the temple unit; a toothed element formed on one of the plunger and the driving member; and a latch member connected to the temple unit and movable relative to the temple unit and the plunger to engage releasably the toothed element.

### FIELD

This disclosure relates to a fluid lens assembly, more particularly to a fluid lens assembly including a fluid lens and a fluid adjusting unit for driving a fluid into the fluid lens or withdrawing the fluid from the fluid lens.

### BACKGROUND

U.S. Pat. No. 8,708,486 discloses a conventional fluid lens assembly including a temple cover 10, a compressible reservoir 11 disposed in the temple cover 10 and adapted to receive a fluid therein, and a caliper actuator connected to the temple cover 10 (see FIG. 1), The caliper actuator includes a temple chassis 15, a wheel 13 mounted to the temple chassis 15, a slider 12 driven by the wheel 13, a compression arm (not shown) that is connected to the slider 12 and that is in contact with a first side surface of the compressible reservoir 11. A second side surface of the compressible reservoir 11 is placed against the temple chassis 15, When the wheel 13 is rotated to drive movement of the slider 12 toward the reservoir 11, the slider 12 presses the compression arm to compress the compressible reservoir 11, thereby driving the fluid in the reservoir 11 to flow.

The conventional fluid lens assembly is disadvantageous in that the compressible reservoir 11 may be undesirably compressed by the compression arm when the wheel 13 is accidentally rotated.

### SUMMARY

Therefore, the object of the disclosure is to provide a fluid lens assembly that can overcome the aforesaid drawback associated with the prior art.

According to this disclosure, there is provided a fluid lens assembly that includes: a fluid lens unit including at least one fluid lens that defines a cavity for receiving a fluid therein; a temple unit connected to the fluid lens unit and having a reservoir that is in fluid communication with the cavity; at least one fluid adjusting unit mounted to the temple unit and including a piston head that is mounted in the reservoir, a plunger that is connected to the piston head, and a driving member that is mounted movably to the temple unit and that is coupled to the plunger for driving sliding movement of the plunger and the piston head relative to the temple unit so as to push the fluid to flow from the reservoir into the cavity or to withdraw the fluid from the cavity into the reservoir; a toothed element formed on one of the plunger and the driving member and a latch member connected to the temple unit and movable relative to the temple unit and the plunger to engage releasably the toothed element so as to position the plunger at a desired position relative to the temple unit.

### BRIEF DESCRIPTION OF THE DRAWINGS

In drawings which illustrate embodiments of the disclosure.

FIG. 1 is a perspective view showing a temple cover, a compressible reservoir, and a caliper actuator of a conventional fluid lens assembly;

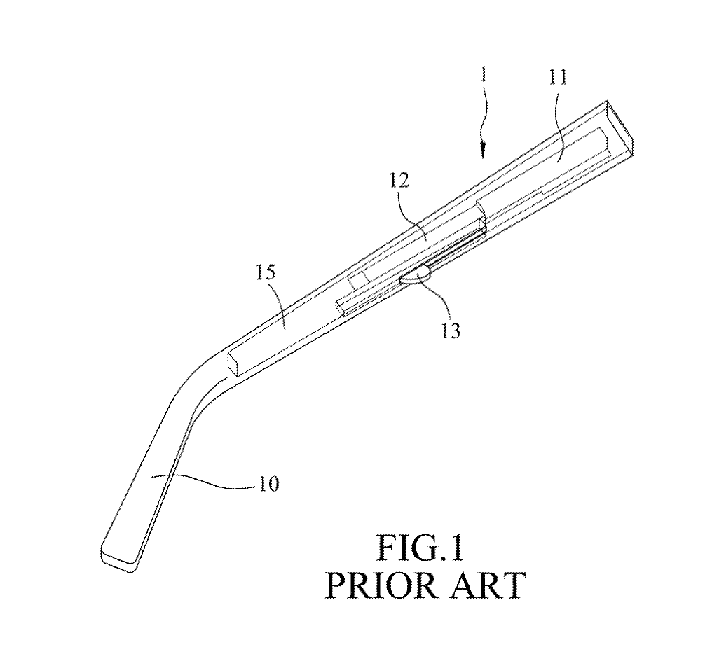

FIG. 2 is a perspective view of the first embodiment of a fluid, lens assembly according to the disclosure;

FIG. 3 is a fragmentary cutaway view of the first embodiment illustrating a state where a latch member is disposed at an engaging position and where a plunger together with a piston head is disposed at a first position;

FIG. 4 is a fragmentary cutaway view of the first embodiment illustrating another state where the latch member is disposed at a disengaging position;

FIG. 5 is a fragmentary cutaway view of the first, embodiment illustrating yet another state where the plunger together with the piston head is disposed at a second position;

FIG. 6 is a schematic front view of the second embodiment of the fluid lens assembly according to the disclosure;

FIG. 7 is a fragmentary schematic view of the third embodiment of the fluid lens assembly according to the disclosure;

FIG. 8 is a fragmentary schematic view of the fourth embodiment of the fluid lens assembly according to the disclosure; and

FIG. 9 is a fragmentary schematic view of the fifth embodiment of the fluid lens assembly according to the disclosure.

### DETAILED DESCRIPTION

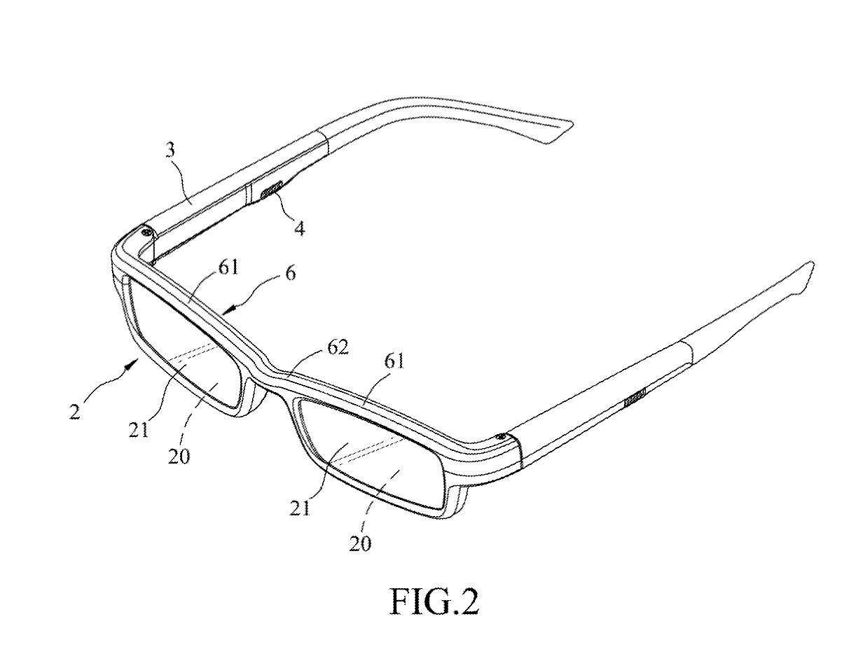

FIGS. 2 to 4 illustrate the first embodiment of a fluid lens assembly according to the present disclosure. The fluid lens assembly includes a fluid lens unit 2, a temple unit 3, at least one fluid adjusting unit a toothed element 44, a latch member 45, and a frame 6,

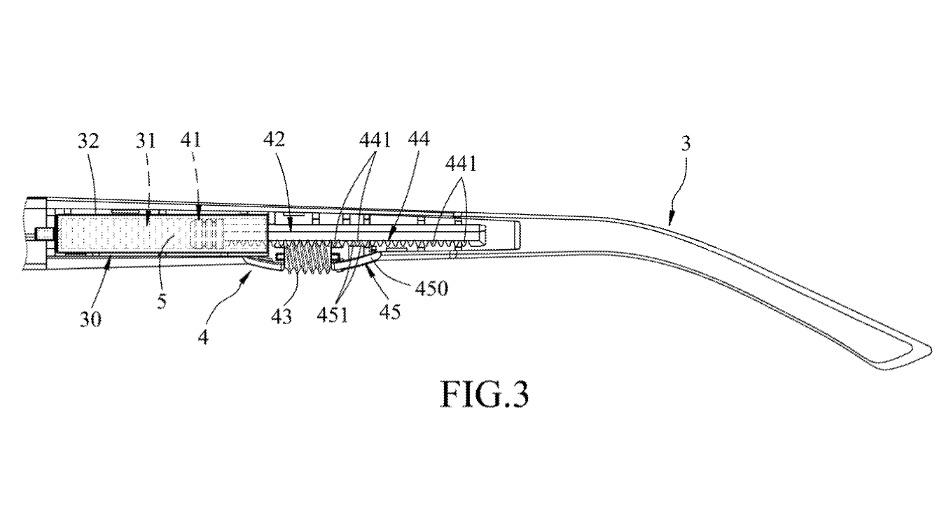

The fluid lens unit 2 includes at least one fluid lens 21 that defines a cavity 20 for receiving a fluid 5 (see FIG. 3) therein.

The temple unit 3 is connected to the fluid lens unit 2, and has a reservoir 31 that is in fluid communication with the cavity 20.

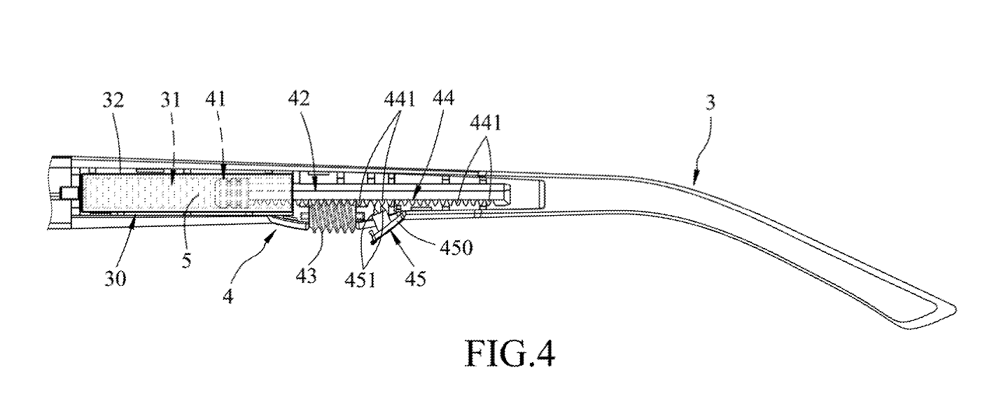

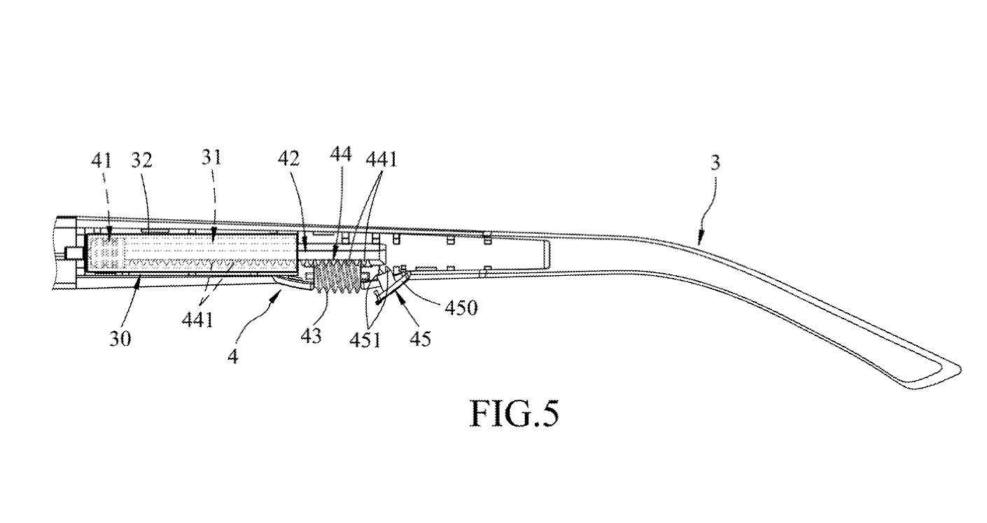

The fluid adjusting unit 4 is mounted to the temple unit 3, and includes a piston, head 41 that. is mounted in the reservoir 31, a plunger 42 that is connected to the piston head 41, and a driving member 43 that is mounted movably to the temple unit 3 and that is coupled to the plunger 42 for driving sliding movement of the plunger 42 and the piston head 41 relative to the temple unit 31 between first and second positions (see FIGS. 4 and 5) so as to drive the fluid 5 to flow from the reservoir 31 into the cavity 20 or to withdraw the fluid 5 from the cavity 20 into the reservoir 31.

The toothed element 44 is formed on one of the plunger 42 and the driving member 43. In this embodiment, the toothed element 44 is formed on and is co-movable with the plunger 42.

The latch member 45 is connected to the temple unit 3, and is movable relative to the temple unit 3 and the plunger 42 between an engaging position (see FIG. 3), in which the latch member 45 engages releasably the toothed element 44 so as to position the plunger 42 at a desired posit ion relative to the temple unit 3 and to prevent sliding movement of the plunger 42, and a disengaging position (see FIG. 4), in which the latch member 45 disengages the toothed element 44 so as to permit sliding movement of the plunger 42 when the driving member 43 is rotated.

In this embodiment, the toothed element 44 includes a plurality of teeth 441 that are formed on a bottom of the plunger 42 and that are distributed and aligned with one another along the length of the plunger 42. The driving member 43 is in the form of a worm gear that is rotatably mounted to the temple unit 3 and that engages the teeth 441 in succession upon rotation thereof. The latch member 45 has a latch arm 450 that is pivoted to the temple unit 3, and at least one latch tooth 451 that protrudes from the latch arm 450 and that is engageable with an adjacent one of the teeth 441 of the toothed element 44.

In this embodiment, the temple unit 3 includes a hollow temple body 30 and a syringe-type barrel 32 that is disposed in the temple body 30 and that defines the reservoir 31,

The frame 6 is connected to the temple unit 3, and has a pair of frame halves 61 and a bridge 62 which interconnects the frame halves 61. The fluid lens unit 2 includes a pair of the fluid lenses 21 that are respectively mounted on the frame halves 61.

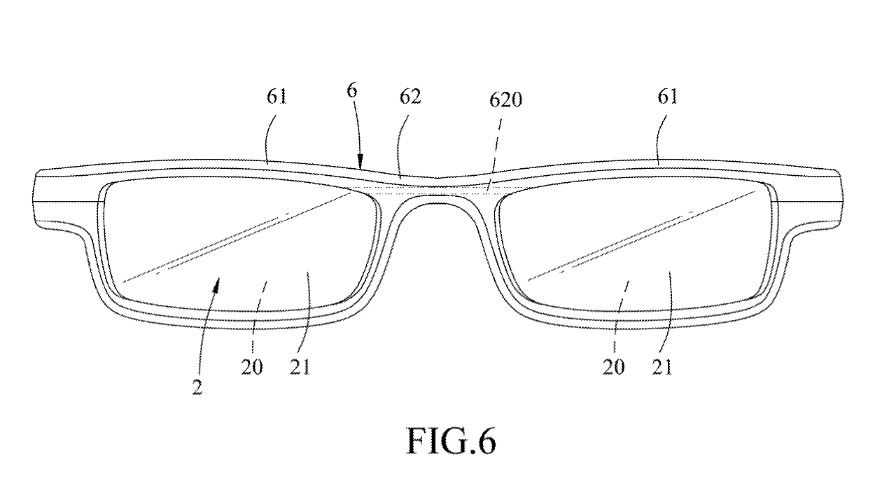

FIG. 6 illustrates the second embodiment of the fluid lens assembly according to the disclosure. The second embodiment differs from the previous embodiment in that the bridge 62 defines a fluid channel 620 that is in fluid communication with the cavities 20 of the fluid lenses

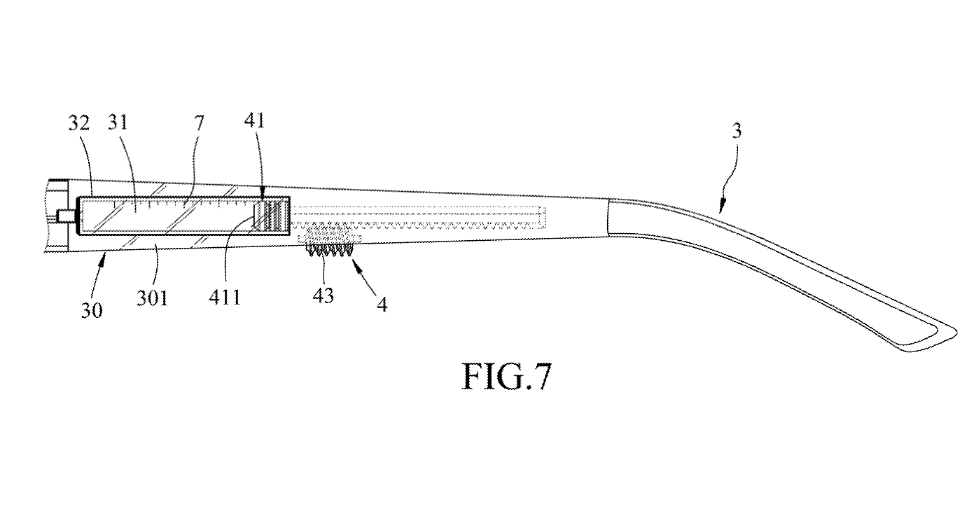

FIG. 7 illustrates the third embodiment of the fluid lens assembly according to the disclosure. The third embodiment differs from the previous embodiments in that the barrel 32 is transparent, that the temple body 30 has s transparent region 301 for viewing the barrel 32, and that the barrel 32 is provided with a diopter indicating scale 7 thereon. The piston head 41 has an end 411 that serves as a pointer for associating with the diopter indicating scale 7 for measuring the diopter of the fluid lenses 21.

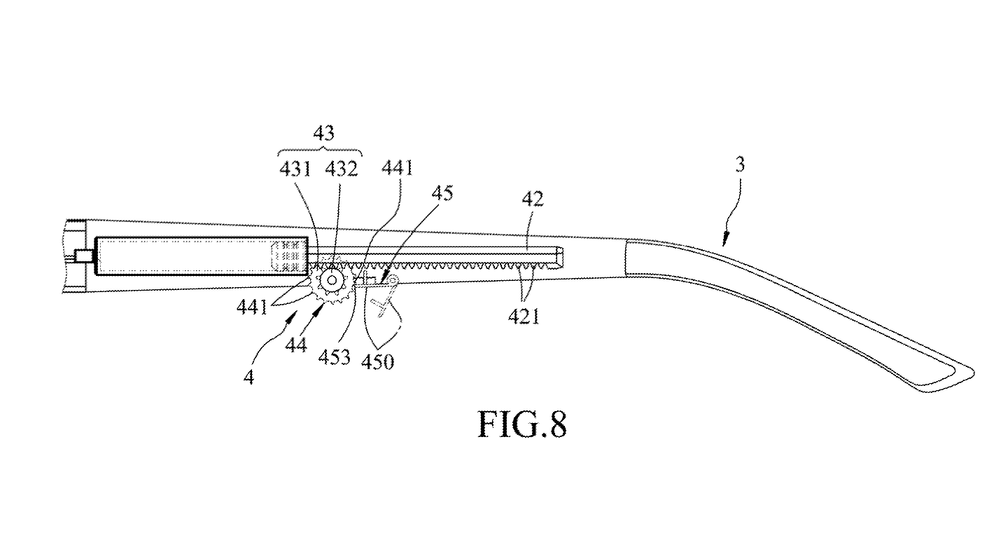

FIG. 8 illustrates the fourth embodiment, of the fluid lens assembly according to the disclosure. The fourth embodiment differs from the first embodiment in that the driving member 43 includes a driving wheel 431 which is rotatably mounted to the temple unit 3, and a wheel gear 432 which is coaxially connected to and co-rotatable with the driving wheel 431, and that the toothed element 44 includes a plurality of teeth 441 which are formed on the driving wheel 431 and which are disposed around an axis of the driving wheel 431. The plunger 42 is formed with a plurality of plunger teeth 421, The wheel gear 432 engages the plunger teeth 421 in succession for driving sliding movement of the plunger 42. The latch member 45 has a latch arm 450 that is pivoted to the temple unit 3 and that has a tapered end 453. The tapered end 453 engages an adjacent one of the teeth 441 of the toothed element 44 when the latch arm 450 is disposed at the engaging position. It is noted that the latch arm 450 also engages releasably the temple unit 3 (not shown) when the latch arm 450 is disposed at the engaging position, so that the latch arm 450 is prevented from accidentally moving from the engaging position to the disengaging position.

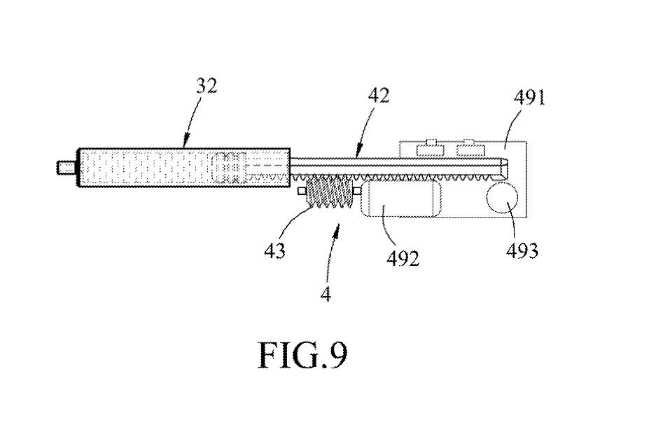

FIG. 9 illustrates the fifth embodiment of the fluid lens assembly according to the disclosure. The fifth embodiment differs from the first embodiment in that the fluid adjusting unit 4 further includes a circuit board 491, a motor 492 and a battery 493 which is electrically connected to the motor 492. The motor 492 is mounted on the circuit board 491, and is coupled to the driving member 43 (in the form of the worm gear) for driving rotation of the driving member 43.

With the inclusion of the toothed element 44 and the latch member 45 in the fluid lens assembly of the present disclosure, the aforesaid drawback associated, with the prior art may be overcome.

While the present disclosure has been described in connection with what are considered the most practical embodiments, it is understood that this disclosure is not limited to the disclosed embodiments but is intended to cover various arrangements included within the spirit and scope of the broadest, interpretation and equivalent arrangements.

What is claimed is:

1. A fluid lens assembly comprising:
a fluid lens unit including at least one fluid ions that defines a cavity for receiving a fluid therein;
a temple unit connected to said fluid lens unit and having a reservoir that is in fluid communication with said cavity;
at least one fluid adjusting unit mounted to said temple unit and including a piston head that is mounted in said reservoir, a plunger that is connected to said piston head, and a driving member that is mounted movably to said temple unit and that is coupled to said plunger for driving sliding movement of said plunger and said piston head relative to said temple unit so as to drive the fluid to flow from said reservoir into said cavity or to withdraw the fluid from said cavity into said reservoir;
a toothed element formed on one of said plunger and said driving member; and
a latch member connected to said temple unit and movable relative to said temple unit and said plunger to engage releasably said toothed element so as to position said plunger at a desired position relative to said temple unit.

2. The fluid lens assembly of claim 1, wherein said toothed element includes a plurality of teeth that are formed, on said plunger and that are distributed and aligned along the length of said plunger, said driving member being in the form of a worm gear, said latch member having a latch arm that is pivoted to said temple unit, and at least one latch tooth that protrudes from said latch arm and that is engageable with an adjacent one of said teeth of said toothed element.

3. The fluid lens assembly of claim 1, wherein said temple unit includes a hollow temple body and a barrel that is disposed in said temple body and that defines said reservoir.

4. The fluid lens assembly of claim 3, wherein said barrel is transparent, said temple body having a transparent region for viewing said barrel.

5. The fluid lens assembly of claim 4, wherein said temple unit is provided with a diopter indicating scale thereon, said piston head having an end that serves as a pointer for associating with said diopter indicating scale for measuring the diopter of said at least one fluid lens.

6. The fluid lens assembly of claim 1, further comprising a frame that has a pair of frame halves and a bridge which interconnects said frame halves, said fluid lens unit including a pair of said fluid lenses that are respectively mounted on said frame halves, said bridge defining a fluid channel that is in fluid communication with said cavities of said fluid lenses.

7. The fluid lens assembly of claim 1, wherein said driving member includes a driving wheel that is rotatably mounted to said temple unit, and a wheel gear that is coaxially connected to and co-rotatable with said driving wheel, said toothed element including a plurality of teeth that are formed on said driving wheel and that are disposed around an axis of said driving wheel, said plunger being formed with a plurality of plunger teeth, said wheel gear engaging said plunger teeth in succession for driving sliding movement of said plunger, said latch member having a latch arm that is pivoted to said temple unit and that has a tapered end that is engageable with an adjacent one of said teeth of said toothed element.
